(19) United States
(12) Patent Application Publication
(10) Pub. No.: US 2010/0070231 A1
(43) Pub. Date: Mar. 18, 2010

(54) SYSTEM AND METHOD FOR TEST CASE MANAGEMENT

(76) Inventor: Patil Suhas HANUMANT, Pune (IN)

Correspondence Address: FRISHAUF, HOLTZ, GOODMAN & CHICK, PC, 220 Fifth Avenue, 16TH Floor, NEW YORK, NY, 10001-7708, US

(21) Appl. No.: 12/555,244

(22) Filed: Sep. 8, 2009

(30) Foreign Application Priority Data
Sep. 5, 2008 (IN) 1887/MUM/2008

(51) Int. Cl. G06F 19/00; G06F 17/30; G06F 3/048

(52) U.S. Cl. 702/123; 715/771; 707/E17.009

(57) ABSTRACT

The invention disclosed relates to a system and method for test case management, wherein the final ‘product’ to be developed is an amalgamation of a variety of ‘modules’ under the ‘product’ umbrella. The variety of ‘modules’ undergo metamorphosis in relation to various phases (that is, from conceptualization to designing to development to testing). At each of these stages, a different team is engaged to perform the relevant functions on the abovementioned modules. Hence, there is a need for a coherent, synchronized and hierarchical classification of the constituents (the modules in relation to their designing parameters, functionality parameters, testing parameters, performance parameters and the like), so that the different teams involved in different phases have a common platform for transferring information and for understanding the transferred information, and essentially for gaining a cohesive overview of the product to be developed.

### FIELD OF THE INVENTION

The present invention relates to the field of application testing. Particularly, the present invention relates to the field of test case management.

### Definitions

In this specification, the following terms have the following definitions as given alongside. These are additions to the usual definitions expressed in the art.
A Test Case in the field of software engineering is a set of conditions or variables using which a tester will determine whether a software application or a software system is working correctly or not. A test case validates one or more system requirements and generates the test result as a ‘pass’ or a ‘fail’ for each of the validated requirements.
A feature is the component of a product whose behaviour and performance are tested for validating and verifying.
A sub feature is the broken down component of a main feature. For example, if a ‘wheel’ is a feature of a product ‘car’, then, the ‘wheel drum’ is a sub feature of the feature ‘wheel’.
A feature parent clause is a label used to identify a main feature. For example, a whole number like ‘1’ can be used as a feature parent clause.
A feature subordinate clause is a label used to identify a sub feature. The feature subordinate clause is appended to the feature parent clause after a feature separator (which can be a period, a hyphen, a comma and the like). For example, a sub feature label will be like ‘1.8’ where ‘1’ is the feature parent clause, ‘.’ is the feature separator and ‘8’ is the feature subordinate clause.
A test case subordinate clause is a label used to identify a test case of a feature or a sub feature. The test case subordinate clause is appended to the feature parent clause/feature subordinate clause after a test case separator (which can be a period, a hyphen, a comma and the like). For example, a test case label will be like ‘1.8-9’ where ‘1’ is the feature parent clause, ‘.’ is the feature separator, ‘8’ is the feature subordinate clause, ‘-’ is the test case separator and ‘9’ is the test case subordinate clause.

### BACKGROUND OF THE INVENTION

The development process for a software application includes a software testing phase which involves verification of the functionalities of each of the features of the product by executing test-cases for all the functionalities. A typical software development workflow includes the following steps:
1) A marketing team defines the product and its required features; and prepares a ‘Marketing Requirements Document’ (MRD) that explains how a product should work from the end user perspective.
2) An engineering team prepares a ‘Functional Specification Document’ (FSD) and an ‘Engineering Design Document’ (EDD) which are based on the MRD and are the engineering translations of the MRD. FSD describes how the individual ‘Graphical User Interface’ (GUI) screens are to be structured and how a user is enabled to interact with the product so that they are able to achieve the functionality described in the MRD. The EDD describes how the individual modules of the product are to be constructed using smaller blocks in order to provide features described in the FSD.
3) A Quality Assurance (QA) team uses the FSD and EDD documents to prepare test specification documents. The test specification documents typically contain a list of test cases, which test the product features one by one to prove that the product developed meets the customer needs.

A typical test specification document is developed in a textual format, such as a Microsoft Word document, that lists a series of actions to be carried out on the developed product and the expected results for those actions. In some cases, the test specification document has references to sections of the FSD which describes the features being tested by the each of the test cases.

As the persons who write the FSD are different from those who write the test cases, the functionalities are not thoroughly tested because the QA team may not be aware of some of the product features. Similarly, the developers may not be aware of how the QA team will be testing the product as the test specifications are verbose and not easy to read, and hence when the QA team finds the defects with the application implementation, the product delivery schedule will be affected because of the extra time required for fixing those defects. Many times, fixing of the defects may introduce another set of new defects. This will add on to the deviation in the product delivery schedule.

The main reason for the lack of communication between the marketing team, the engineering team and the QA team is the non-standard structure used to document the product features and test cases and the non-automated means of judging the coverage of testing for the features implemented.

One of the approaches used for overcoming the disadvantages of the aforementioned problems is the use of a Requirement Traceability Matrix (RTM) which is adapted to allow the linkage of the product features and test cases by preparing a two dimensional matrix with a header row describing the features and a first column describing the test cases. The person who uses the RTM puts an ‘X’ where a feature and a test case intersect, to indicate the linkage of that test case with the feature.

Requirements traceability typically deals with the documenting of the relationships between the requirements and other development artifacts. The purpose of an RTM is to facilitate:
the understanding of the product under development and its different artifacts; and
the ability to manage changes.

The tools available presently in the market (like HP Quality Center and Rational Test Manager) use a scheme of “drag-and-drop”. This approach uses two lists; one of which is the requirements list and the other contains the list of the test cases and optionally, the description of the test cases. The user is supposed to select a requirement from the first list by clicking a button on the mouse and drag the mouse to the test case in the second list and release the button to instruct the system to link the requirement and the test case. When the size of the lists of requirements/test cases increases, the process of dragging and dropping becomes very tedious to carry out. Moreover, when a requirement changes, the corresponding test cases also have to be changed. The problem becomes more difficult when a new requirement is added and the user has to go through the entire set of test cases to see which test case matches the new requirement.

Another approach is the use of a classification tree. This approach partitions the testing process and it uses a descriptive tree-like notation. This approach is designed to be made suitable for automation. The dependence of this approach on the GUI and the fact that a lot of manual work is required to weed out irrelevant test cases, has made this approach only theoretical in appeal and not a practical solution for actual implementation.

Several attempts have been made to manage the test cases as described in the patent documents given below.

U.S. Pat. No. 5,542,043 discloses an enumeration method for a minimal number of test cases for systems with interacting elements. The disclosed method operates the relationships between the elements and the number of characteristics evaluated for each element while generating and enumerating the test cases. The method enumerates a table of test cases for each element and each relationship between elements using deterministic procedures and random procedures according to the applicability. However, the scope of the disclosure in U.S. Pat. No. 5,542,043 is limited to a minimal number of test cases and if the number of test cases has to be increased beyond a threshold level, the method will become very complicated.

Further, Indian Patent Application No. 548/MUMNP/2004 discloses a system and method for testing an application including modules capable of reading data from one or more data tables and providing the data as input to the application. The input data is correlated by the appropriate test case, so that each module may provide different input data for each test case. The system also includes a controller that executes the modules. The controller is capable of determining an execution order for the modules by reading a flow table. The flow table correlates each test case with one or more modules, and further correlates each module within the test case with an execution order. But, the execution cost required for the controller will adversely affect the processing efficiency of the host system in which the testing system is installed.

Several attempts have also been made to process design diagrams and code execution paths to link features to test cases as described below.

United States Patent Application No. US20040088677A1 discloses a method for generating a test suite. The method disclosed includes deriving a set of use case constraints and generating a test suite based upon the set of derived use case constraints. US20040088677 also discloses a system that generates a test suite which includes a deriver that derives a set of use case constraints and a generator that generates a test suite based upon the set of use case constraints. The method disclosed herein minimizes the number of test cases that guarantees a certain level of coverage of potential operations and sequences and takes into account both of those places where combinatorial explosions may occur, a test case being a sequence of these operations.

Further, United States Patent Application No. US20040143819A1 discloses a generic software testing system and mechanism for use in distributed object-oriented systems. The system disclosed directly utilizes the class diagrams (or interface definitions) and the sequence diagrams to automatically generate the execution codes and test template required for testing the software system, wherein the class diagram data, the interface definition data and the sequence diagram data are generated by a software development tool of distributed object-oriented system.

Still further, United States Patent Application No. US20040133881A1 discloses a system for generating a minimal set of test cases characterized by a linear range of integral values. The system includes a test generator programmed to test code paths in the software under test, wherein the code paths are sensitive to the lengths of tokens in the input data sent to the software under test and the object of the testing is to determine the response of the code paths to tokens of different lengths.

Finally, PCT Application No. WO2008067265A2 discloses a test generator which takes data flow diagrams and uses requirements-based templates, selective signal propagation and range comparison and intersection to generate test cases containing test vectors for those diagrams. Test case template values may be described numerically or by a formula. The formula disclosed in WO2008067265A2 is an expression using arithmetic or logical operators and basic terms that may refer to diagram-specific values such as block properties, the ports of a block, diagram periodic rate and the like.

All the abovementioned methods require excessive processing time and resources to cover the testing of the products extensively. Therefore, there is felt a need for a system for test case management, wherein:
a low cost standard method is provided for the classification of test cases;
a hierarchical classification and enumeration of test cases are provided with least effort and resources;
the system is user friendly; and
the reports, graphs and charts generated by the system are easily understandable, very informative and are easy to preview and refer.

### OBJECTS OF THE INVENTION

It is an object of the present invention to provide a low cost system for test case management, which performs a standard method for the classification of test cases.

It is another object of the present invention to provide a system for hierarchical classification and enumeration of test cases with least effort and resources.

It is still another object of the present invention to provide a user friendly system for test case management.

One more object of the present invention is to provide a system for test case management, wherein the reports, graphs and charts generated by the system are easily understandable, very informative and are easy to preview and refer.

### SUMMARY OF THE INVENTION

In accordance with the present invention, there is provided a system for managing test cases comprising:
a user interface module adapted a) to co-operate with users to receive instructions for managing said test cases; and b) to communicate the information related to said test cases to said users;
a product management module comprising:
   i. a product creation module adapted a) to receive instructions from said user interface module; and b) to create products for which test cases are to be managed;
   ii. a feature and test case creation module adapted a) to receive instructions from said user interface module; and b) to enable product managers and test managers to download spreadsheet templates, populate the details of the features, sub features and test cases for said created products in said downloaded spreadsheet templates and to upload said populated spreadsheet templates to said feature and test case creation module;
   iii. an indicia generation module adapted to co-operate with said feature and test case creation module to generate labels for each of said created features, said created sub features and said created test cases of said created products;
   iv. a test suite creation module adapted to receive instructions from said user interface module to create test suites having groups of said created test cases which are related to each other functionally; and
   v. a build assignment module adapted to receive instructions from said user interface module to assign builds to said created products;
a platform module adapted a) to receive instructions from said user interface module; and b) to assign platforms having at least one element to said created test suites;
a test run module adapted a) to receive instructions from said user interface module; and b) to enable testers to download spreadsheets having said created test suites for said created products, to populate the test results for said created test cases in said created test suites in said downloaded spreadsheets and to upload said populated spreadsheets;
a test report and analytics module adapted a) to receive instructions from said user interface module; and b) to generate test reports, graphs and charts having the details asked by said users;
an administration module adapted a) to receive instructions from said user interface module; and b) to enable restricted access to said users to said system's functionalities based on the hierarchical level of said users; and
a database adapted to co-operate with all said modules of said system to receive and store the details of said users, said created products, said created features, said created sub features, said created test cases, said created test suites, said assigned builds, said assigned platforms and said test results for future retrieval;
characterized in that said test report and analytics module is adapted to display said created features, said created sub features, said created test cases, said generated labels and said test results in the same window.

In accordance with another aspect of the present invention, the system for managing test cases includes a mapping module adapted a) to co-operate with the feature and test case creation module; b) to enable product managers to give identifiers to the created features and the created sub features and to enable test managers to give identifiers to the created test cases; and c) to map the created test cases to corresponding created features or created sub features.

Typically, said mapping module is adapted to map said created test cases to said created features or said created sub features in such a way that one test case can be mapped only to one feature or sub feature using a unique identifier.

Typically, said user interface module is adapted to co-operate with a bug management module which is adapted to co-operate with said database to display and manage the details of bugs associated with said created products.

Typically, said user interface module is adapted to co-operate with a knowledge management module which is adapted to manage artifacts having information related to the management of test cases.

Typically, said test suite creation module is adapted to enable test managers to a) download said created test cases; b) to group said created test cases into test suites; and c) to upload said test suites.

In accordance with the present invention, there is provided a method for managing test cases, said method comprising the following steps:
creating products whose features are to be tested by testers;
identifying major features of said created products;
labeling said identified features with feature parent clauses;
creating sub features by breaking down said labeled features;
labeling said created sub features by appending feature separators and feature subordinate clauses to said feature parent clauses;
creating test cases corresponding to each of said features and sub features; and
labeling said created test cases by appending test case separators and test case subordinate clauses to corresponding feature parent clauses or feature subordinate clauses.

Typically, the method for managing test cases includes:
creating test suites to group functionally related test cases;
assigning builds to said created products;
assigning platforms with at least one element to said created test suites;
executing said test cases grouped into said created test suites and obtain test results for each of said test cases;
storing the details of users, said created products, said created features, said created sub features, said created test cases, said created test suites, said assigned builds, said assigned platforms and said test results in a database;
generating test reports having said details displayed according to the instructions given by said user; and
generating graphs and charts on said test results according to the instructions given by said user.

In accordance with another aspect of the present invention, said step of labeling said features, said step of labeling said sub features and said step of labeling said test cases are carried out manually.

In accordance with another aspect of the present invention, said step of labeling said features, said step of labeling said sub features and said step of labeling said test cases are carried out by automated processes.

In accordance with another aspect of the present invention, there is provided an alternative method for managing test cases, said method comprising the following steps:
creating products whose features are to be tested by testers;
identifying features and sub features for said created products;
labeling said identified features and sub features with unique feature identifiers;
creating test cases corresponding to each of said features and sub features;
labeling said created test cases with unique test case identifiers;
creating a table having a plurality of cells arranged in a plurality of rows and a plurality of columns so that each cell is identified by the unique co-ordinates of a row and a column;
mapping said features and sub features with said created test cases with the help of said created table by placing said feature identifier in a cell of a row and placing corresponding test case identifier in another cell of the same row; and
iterating said step of mapping for all said created test cases.

### BRIEF DESCRIPTION OF THE ACCOMPANYING DRAWINGS

The system for test case management in accordance with this invention is now described with the help of accompanying drawings, in which:

FIG. 1 illustrates the block diagram of the system; and

FIG. 2 illustrates the flow diagram of the method performed by the system.

### DETAILED DESCRIPTION OF THE INVENTION

The drawings and the description thereto are merely illustrative of a system for test case management in accordance with this invention and only exemplify the system and method of the invention and in no way limit the scope thereof.

The present invention envisages a system and method for test case management, wherein the final ‘product’ to be developed is an amalgamation of a variety of ‘modules’ under the ‘product’ umbrella. The variety of ‘modules’ undergo metamorphosis in relation to various phases (that is, from conceptualization to designing to development to testing). At each of these stages, a different team is engaged to perform the relevant functions on the abovementioned modules. Hence, there is a need for a coherent, synchronized and hierarchical classification of the constituents (the modules in relation to their designing parameters, functionality parameters, testing parameters, performance parameters and the like), so that the different teams involved in different phases have a common platform for transferring information and for understanding the transferred information, and essentially for gaining a cohesive overview of the product to be developed.

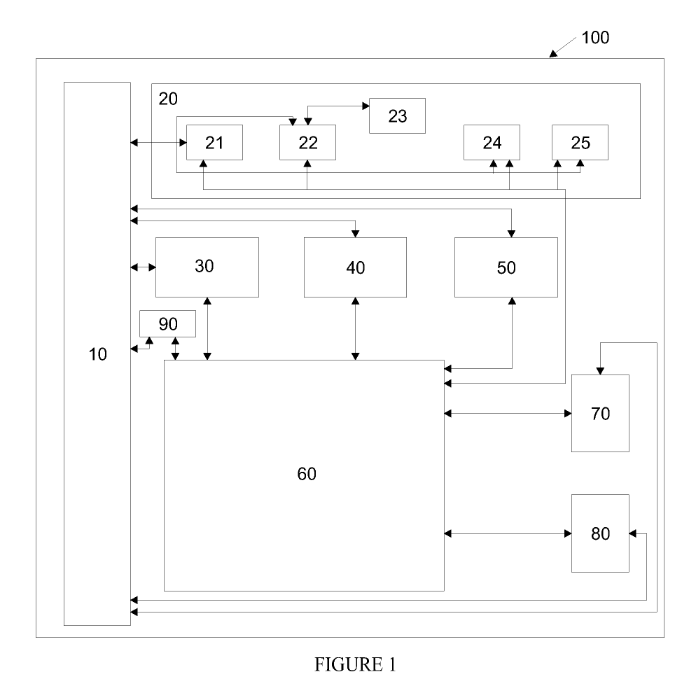

Referring to the accompanying drawings, FIG. 1 illustrates the block diagram of the system for test case management indicated generally by the reference numeral 100. The main components of the system 100 are a user interface module 10, a product management module 20, a platform module 30, a test run module 40, a test report and analytics module 50, a database 60, a bug management module 70, a knowledge management module 80 and an administration module 90. The product management module 20 has a product creation module 21, a feature and test case creation module 22, an indicia generation module 23, a test suite creation module 24 and a build assignment module 25.

The user interface module (UIM) 10 interacts with the users through Graphical User Interfaces (GUIs). The UIM 10 receives instructions from the users to manage the test cases. The UIM 10 communicates with all the other modules of the system 100 to carry out the users' instructions and to provide the required information to the users. The administrative module 90 provides restricted access to the users to the system's functionalities based on the hierarchical level of the users. The typical users of the system 100 include product managers, Research and Development (R&D) personnels, Quality Assurance (QA) team members, test managers and testers.

The product management module (PMM) 20 has a product creation module (PCM) 21 which receives instructions from the UIM 10 which in turn receives instructions from product managers for creating new products for which the test cases are to be managed. For each of the products, the product managers will provide details including the product version, product components and feature specifications. The PCM 21 will then co-operate with a database 60 to store all the details of the created products.

The feature and test case creation module (FTCCM) 22 of the PMM 20 receives instructions from product managers and test managers through the UIM 10 for downloading a spreadsheet template which has columns provided for populating version number, features, feature labels, sub features, sub feature labels, feature release dates, feature status, test cases, test case labels, test case descriptions, test case execution steps, test case outcomes, test results and the like. The product managers identify the major features for each of the created products. The identified major features are then labeled by feature parent clauses which are whole numbers (1, 2, 3 . . . ). The product managers then break down the identified major features into sub features. The sub features are then labeled by appending feature separators and feature subordinate clauses to corresponding feature parent clauses. The feature separator can typically be a period, a comma, a hyphen, a semi-colon, a colon and the like. An example of a sub feature label is ‘1.5’ where ‘1’ is the feature parent clause, ‘.’ is the feature separator and ‘5’ is the feature subordinate clause. Table 1 given below illustrates the labeling of features and sub features for a product ‘car’.

TABLE 1

| Feature Label | Feature Description |
|---|---|
| 1 | Engine |
| 1.1 | Crankshaft |
| 1.2 | Pistons |
| 1.2.1 | Piston rings |
| 1.2.2 | Pin |
| 1.3 | Valves |
| 2 | Body |
| 2.1 | Outer skin |
| 2.2 | Seats |
| 2.3 | Paint |
| 3 | Transmission |
| 3.1 | Gear box |
| 3.1.1 | Gears |
| 3.1.2 | Gear shift mechanism |
| 3.2 | Transmission rod |
| 3.3 | Brake drums |
| 4 | Wheels |
| 4.1 | Wheel Drum |
| 4.2 | Tyre |

The aforementioned labels are characterized by the following properties:
1) All features at the same level differ in identity by the feature subordinate clause (for example, a number) followed by the last period (feature separator) in the label. Thus, feature ‘1.1.2’ and feature ‘1.1.3’ are both derived from the same parent feature.
2) The parent of the sub feature can be determined by simply ignoring the last feature separator (for example, the last period) in the label followed by the last feature subordinate clause (the last number). Thus, parent of the feature ‘1.1.2’ is ‘1.1’
3) Labels which do not have a feature separator (for example, a period) are features which cannot be inherited by any other feature. Thus, the feature ‘1’ , that is, the ‘engine’, is distinct from any other feature of the product ‘car’ and cannot be a sub feature of any other feature.

This method enables a user to classify the features of a product by their hierarchy. As features are typically grouped, and hence localized in one area of the document, it is easy for an expert of that feature to quickly visualize the product in accordance with its constituents and to quickly focus on omissions or errors in its description.

The test managers design test cases for each of the features and/or sub features. The test cases are then labeled by appending test case separators and test case subordinate clauses to corresponding feature parent clauses or feature subordinate clauses. The test case separator can typically be a period, a comma, a hyphen, a semi-colon, a colon and the like. An example of a test case label is ‘1.5-6’ where ‘1’ is the feature parent clause, ‘.’ is the feature separator, ‘5’ is the feature subordinate clause, ‘-’ is the test case separator and ‘6’ is the test case subordinate clause.

The Table 2 given below illustrates 5 test cases for the sub feature ‘Gears’ of the sub feature ‘Gear box’ of the feature ‘Transmission’ illustrated in Table 1. In this illustration, a period (‘.’) is used as the feature separator and the test case separator.

TABLE 2

| Test-case | |
|---|---|
| Label | Description |
| 3.1.1.1 | Can gears engage without making noise |
| 3.1.1.2 | Can gears take the load of fully loaded vehicle |
| 3.1.1.3 | Can gears disengage without making noise |
| 3.1.1.4 | Can gears work for 24 hours of continuous operation without |
| | overheating |
| 3.1.1.5 | Can gears function for 10 days of constant run without |
| | wearing out |

The Table 3 given below illustrates 5 test cases for the sub feature ‘Crankshaft’ of the feature ‘Engine’ illustrated in Table 1. In this illustration also, a period (‘.’) is used as the feature separator and the test case separator.

TABLE 3

| Test-case | |
|---|---|
| Label | Description |
| 1.1.1 | Can crankshaft take the load of fully loaded vehicle |
| 1.1.2 | Can crankshaft turn at high speed without wobbling |

The Table 4 given below illustrates the final mapping of a test case label to the corresponding feature label. In this example, a ‘.’ is the feature separator and a ‘-’ is the test case separator.

TABLE 4

| | Feature | Test case | |
|---|---|---|---|
| No. | Label | Label | Test case Description |
| 1 | 1 | | Engine |
| 2 | 1.1 | 1.1-1 | Crankshaft should not wobble |
| | | | at high speed |
| 3 | 1.2 | | |
| 4 | 1.2.1 | 1.2.1-1 | Check whether the rings are |
| | | | not abrasive |
| 5 | 1.2.1 | 1.2.1-2 | Check whether the gap |
| | | | between the rings and the |
| | | | piston walls is less than the |
| | | | tolerance value |
| 6 | 1.2.2 | | |

This labeling process is a hierarchical classification and enumeration method of test cases which can be performed with least effort and resources. Thus the downloaded spreadsheet templates can be populated by the product managers and the test managers with the version number, features, feature labels, sub features, sub feature labels, feature release dates, feature status, test cases, test case labels, test case descriptions, test case execution steps for the created products. The spread sheet thus populated can then be uploaded back to FTCCM 22.

The feature and test case labeling process described above is done manually by the product managers and test managers. The labeling process can also be automated. For the automation, the FTCCM 22 co-operates with an indicia generation module 23, which generates the labels for each of the created features using feature parent clauses, for each of the sub features by appending the feature parent clauses with feature separators and feature subordinate clauses and for each of the test cases by appending the feature parent clauses/feature subordinate clauses with test case separators and test case subordinate clauses. The FTCCM 22 also co-operates with the database 60 to store the version number, features, feature labels, sub features, sub feature labels, feature release dates, feature status, test cases, test case labels, test case descriptions, test case execution steps for the created products.

The test suite creation module (TSCM) 24 of the PMM 20 receives instructions from test managers through the UIM 10 to create test suites having groups of created test cases which are related to each other functionally. The test manager downloads the created test cases from TSCM 24, groups the functionally related test cases into test suites and uploads the created test suites back to TSCM 24. The TSCM 24 then stores the details of the created test suites in the database 60.

The build assignment module (BAM) 25 of the PMM 20 receives instructions from R&D personnels (developers) through the UIM 10 to assign builds to the created products and then stores the details of the assigned builds in the database 60.

The platform module 30 receives instructions from R&D personnels (testers) through the UIM 10 to assign platforms having at least one element to the created test suites. The created products have to be tested in various conditions and environments. For example, an online software application needs to be tested with different web browsers on different devices and operating systems; an automobile has to be tested on different surfaces and in different weather conditions; and a government service needs to be tested for different demographics and for different regions. To ensure the reliability and robustness of the created products, the platform module assigns the test suites for the created products with different configurations and combinations of multiple platform elements to ensure the comprehensive testing of the created products in all possible conditions. The platform module 30 then stores all the details of the assigned platforms in the database 60.

The test run module 40 receives instructions from testers through the UIM 10 to download spreadsheets having the test suites for the created products. The tester then executes each of the test cases in the test suites and populates the spreadsheets with the test results (as ‘pass’ or ‘fail’) corresponding to each of the test cases and then uploads the populated spreadsheets back to the test run module 40. The spreadsheets will also be populated with the bugs, issues or defects identified during the execution of each of the test cases. The test run module 40 then stores the test results and the bug details corresponding to each of the test cases in the database 60.

The test report and analytics module (TRAM) 50 receives instructions from users through the UIM 10 to generate reports, real time graphs and charts having the details asked by the users. For generating the reports, graphs and charts, the TRAM 50 fetches all the required details from the database 60. The reports display features, sub features, test cases and test results along with their labels in the same window, making it easier for the user to browse through and refer. These reports are easily understandable by the user as he can easily make out the feature/sub feature to which each test case belongs from the labels. Also, he can easily understand the performance of the functionalities corresponding to each feature/sub feature using the test results.

The bug management module 70 receives instructions from users through the UIM 10 to track all the bugs, issues or defects identified during the process of execution of test cases. The bug management module 70 fetches these details from the database 60. Thus the complete traceability between any issue, the corresponding build, test case and product feature is ensured. This enables product managers to estimate the product release dates in a better way.

The knowledge management module (KMM) 80 receives instructions from users through the UIM 10. The (KMM) 80 manages all the artifacts having information related to the management of test cases in co-operation with the database 60. Whenever the user needs any tips or help related to how to manage the test cases, he can query the database 60 through the KMM 80.

The system 100 provides an open interface to automate the interchange of product and test information with any third party test automation tool or process. For example, the product feature specifications can be imported from any Product Lifecycle Management (PLM) application; test suites can be exported for execution by third party testers; and the identified defects can be uploaded during automated test runs and can be integrated with third party issue tracking systems. The system's 100 labeling scheme ensures consistent relationship between the different pieces of information.

The system 100 provides a unified test management solution for all of the software and service products. The system 100 can support thousands of users across multiple business units and multiple geographical regions. Hence this system 100 is highly scalable. The role based access ensures confidentiality. Online and web-based tools deliver ease of administration and usage.

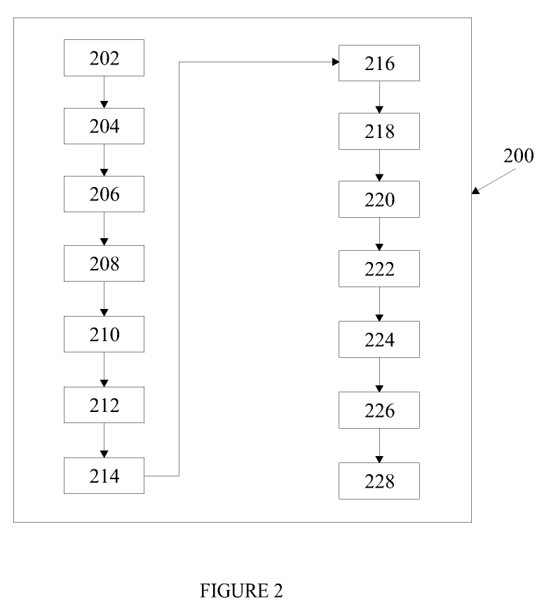

FIG. 2 illustrates the flow diagram of the method performed by the system in accordance with the present invention, indicated generally by the reference numeral 200. The method comprises the following steps: creating products whose features are to be tested by testers (step 202); identifying major features of said created products (step 204); labeling said identified features with feature parent clauses (step 206); creating sub features by breaking down said labeled features (step 208); labeling said created sub features by appending feature separators and feature subordinate clauses to said feature parent clauses (step 210); creating test cases corresponding to each of said features and sub features (step 212); labeling said created test cases by appending test case separators and test case subordinate clauses to corresponding feature parent clauses or feature subordinate clauses (step 214); creating test suites to group functionally related test cases (step 216); assigning builds to said created products (step 218); assigning platforms with at least one element to said created test suites (step 220); executing said test cases grouped into said created test suites and obtain test results for each of said test cases (step 222); storing the details of said users, said created products, said created features, said created sub features, said created test cases, said created test suites, said assigned builds, said assigned platforms and said test results in a database (step 224); generating test reports having said details displayed according to the instructions given by said user (step 226); and generating graphs and charts on said test results according to the instructions given by said user (step 228).

The advantages of the described method of labeling are as follows:
1) Users can determine the feature label and the feature being tested by a particular test case by simply removing the test case separator (for example, the last period) and the test case subordinate clause (a number) following it. This eliminates the need to draw a traceability matrix and/or a link feature for majority of the software development needs.
2) As test case labels are obtained by appending a test case separator (for example, a period) and a test case subordinate clause (a number) to the label of the feature being tested, implicit grouping of test cases is achieved and no separate classification tree has to be developed. As the grouping is done through numbering, no graphical user interface and accompanying overhead of linking is required.
3) As each feature of a product is worked upon by a person who may be an expert only in that specific feature, delegation of broken-down features and associated test cases with respect to that feature and its sub features becomes easy.
4) Identification of the sub features and features for updation becomes very simple.

In accordance with another aspect of the present invention, a user can eliminate the specialized numbering scheme and retrofit the method for a situation where feature labels (feature identifiers) and test case labels (test case identifiers) are predefined and can not be changed. To implement this aspect, the system 100 includes a mapping module adapted a) to co-operate with the feature and test case creation module 22; b) to enable product managers to give identifiers to the created features and the created sub features and to enable test managers to give identifiers to the created test cases; and c) to map the created test cases to corresponding created features or created sub features.

The mapping module maps the test cases to the created features or the created sub features in such a way that one test case can be mapped only to one feature or sub feature using a unique identifier. That is, for each test case a unique mapping to the corresponding feature or sub feature is established. The different steps involved in this method are: a) creating products whose features are to be tested by testers; b) identifying features and sub features for the created products; c) labeling the identified features and sub features with unique feature identifiers; d) creating test cases corresponding to each of the features and sub features; e) labeling the created test cases with unique test case identifiers; f) creating a table having a plurality of cells arranged in a plurality of rows and a plurality of columns so that each cell is identified by the unique co-ordinates of a row and a column; g) mapping the features and sub features with the created test cases with the help of the created table by placing the feature identifier in a cell of a row and placing the corresponding test case identifier in another cell of the same row; and h) iterating the step of mapping for all the created test cases.

Thus in another implementation, the feature identifiers and the test case identifiers can be represented in the manner described in Table 5 and Table 6 given below:

TABLE 5

| Feature | Feature |
|---|---|
| Identifier | description |
| F1 | Engine |
| F2 | Crankshaft |
| F3 | Pistons |
| F4 | Piston rings |
| F6 | Pin |

TABLE 6

| | Feature | Test case | |
|---|---|---|---|
| No. | Identifier | Identifier | Test case description |
| 1 | F1 | | Engine |
| 2 | F2 | TC39 | Crankshaft should not wobble at |
| | | | high speed |
| 3 | F3 | | |
| 4 | F4 | TC54 | Check whether the rings are not |
| | | | abrasive |
| 5 | F4 | TC27 | Check whether gap between the |
| | | | rings and piston walls is less than |
| | | | tolerance |
| 6 | F6 | | |

In the Table 6, the feature F4 which refers to “Piston rings” in Table 5 is tested by the test case TC54 which reads “Check whether the rings are not abrasive”. Similarly the feature F2 is tested by TC39. Clearly, this approach is harder to use as an extra mapping between the feature labels and the test case labels is required to be managed. However, this approach enables creation of traceability between requirements and test cases without changing the predefined classification. This method also enables traceability to be introduced between test cases those are already formally defined, but which don't have requirements tied to them. The requirements can now be linked through a spreadsheet using this method.

### Technical Advancements

The technical advancements of the present invention include the realization of a system for test case management, wherein:
a low cost standard method is provided for the classification of test cases;
a hierarchical classification and enumeration of test cases are provided with least effort and resources;
the system is user friendly; and
the reports, graphs and charts generated by the system are easily understandable, very informative and are easy to preview and refer.

While considerable emphasis has been placed herein on the particular features of this invention, it will be appreciated that various modifications can be made, and that many changes can be made in the preferred embodiments without departing from the principles of the invention. These and other modifications in the nature of the invention or the preferred embodiments will be apparent to those skilled in the art from the disclosure herein, whereby it is to be distinctly understood that the foregoing descriptive matter is to be interpreted merely as illustrative of the invention and not as a limitation.

1. A system for managing test cases comprising:
a user interface module adapted a) to co-operate with users to receive instructions for managing said test cases; and b) to communicate the information related to said test cases to said users;
a product management module comprising:
i. a product creation module adapted a) to receive instructions from said user interface module; and b) to create products for which test cases are to be managed;
ii. a feature and test case creation module adapted a) to receive instructions from said user interface module; and b) to enable product managers and test managers to download spreadsheet templates, populate the details of the features, sub features and test cases for said created products in said downloaded spreadsheet templates and to upload said populated spreadsheet templates to said feature and test case creation module;
iii. an indicia generation module adapted to co-operate with said feature and test case creation module to generate labels for each of said created features, said created sub features and said created test cases of said created products;
iv. a test suite creation module adapted to receive instructions from said user interface module to create test suites having groups of said created test cases which are related to each other functionally; and
v. a build assignment module adapted to receive instructions from said user interface module to assign builds to said created products;
a platform module adapted a) to receive instructions from said user interface module; and b) to assign platforms having at least one element to said created test suites;
a test run module adapted a) to receive instructions from said user interface module; and b) to enable testers to download spreadsheets having said created test suites for said created products, to populate the test results for said created test cases in said created test suites in said downloaded spreadsheets and to upload said populated spreadsheets;
a test report and analytics module adapted a) to receive instructions from said user interface module; and b) to generate test reports, graphs and charts having the details asked by said users;
an administration module adapted a) to receive instructions from said user interface module; and b) to enable restricted access to said users to said system's functionalities based on the hierarchical level of said users; and
a database adapted to co-operate with all said modules of said system to receive and store the details of said users, said created products, said created features, said created sub features, said created test cases, said created test suites, said assigned builds, said assigned platforms and said test results for future retrieval;
characterized in that said test report and analytics module is adapted to display said created features, said created sub features, said created test cases, said generated labels and said test results in the same window.

2. A system for managing test cases comprising:
a user interface module adapted a) to co-operate with users to receive instructions for managing said test cases; and b) to communicate the information related to said test cases to said users;
a product management module comprising:
i. a product creation module adapted a) to receive instructions from said user interface module; and b) to create products for which test cases are to be managed;
ii. a feature and test case creation module adapted a) to receive instructions from said user interface module; and b) to enable product managers and test managers to download spreadsheet templates, populate the details of the features, sub features and test cases for said created products in said downloaded spreadsheet templates and to upload said populated spreadsheet templates to said feature and test case creation module;
iii. a test suite creation module adapted to receive instructions from said user interface module to create test suites having groups of said created test cases which are related to each other functionally; and
iv. a build assignment module adapted to receive instructions from said user interface module to assign builds to said created products;
a platform module adapted a) to receive instructions from said user interface module; and b) to assign platforms having at least one element to said created test suites;
a test run module adapted a) to receive instructions from said user interface module; and b) to enable testers to download spreadsheets having said created test suites for said created products, to populate the test results for said created test cases in said created test suites in said downloaded spreadsheets and to upload said populated spreadsheets;
a test report and analytics module adapted a) to receive instructions from said user interface module; and b) to generate test reports, graphs and charts having the details asked by said users;
an administration module adapted a) to receive instructions from said user interface module; and b) to enable restricted access to said users to said system's functionalities based on the hierarchical level of said users; and
a database adapted to co-operate with all said modules of said system to receive and store the details of said users, said created products, said created features, said created sub features, said created test cases, said created test suites, said assigned builds, said assigned platforms and said test results for future retrieval;
characterized in that said system includes a mapping module adapted a) to co-operate with said feature and test case creation module; b) to enable product managers to give identifiers to said created features and said created sub features and to enable test managers to give identifiers to said created test cases; and c) to map said created test cases to corresponding created features or created sub features.

3. A system for managing test cases as claimed in claim (2), wherein said mapping module is adapted to map said created test cases to said created features or said created sub features in such a way that one test case can be mapped only to one feature or sub feature using a unique identifier.

4. A system for managing test cases as claimed in claim (1), wherein said user interface module is adapted to co-operate with a bug management module which is adapted to co-operate with said database to display and manage the details of bugs associated with said created products.

5. A system for managing test cases as claimed in claim (1), wherein said user interface module is adapted to co-operate with a knowledge management module which is adapted to manage artifacts having information related to the management of test cases.

6. A system for managing test cases as claimed in claim (1), wherein said test suite creation module is adapted to enable test managers to a) download said created test cases; b) to group said created test cases into test suites; and c) to upload said test suites.

7. A method for managing test cases, said method comprising the following steps:
creating products whose features are to be tested by testers;
identifying major features of said created products;
labeling said identified features with feature parent clauses;
creating sub features by breaking down said labeled features;
labeling said created sub features by appending feature separators and feature subordinate clauses to said feature parent clauses;
creating test cases corresponding to each of said features and sub features; and
labeling said created test cases by appending test case separators and test case subordinate clauses to corresponding feature parent clauses or feature subordinate clauses.

8. A method for managing test cases as claimed in claim (7), which includes:
creating test suites to group functionally related test cases;
assigning builds to said created products;
assigning platforms with at least one element to said created test suites;
executing said test cases grouped into said created test suites and obtain test results for each of said test cases;
storing the details of users, said created products, said created features, said created sub features, said created test cases, said created test suites, said assigned builds, said assigned platforms and said test results in a database;
generating test reports having said details displayed according to the instructions given by said user; and
generating graphs and charts on said test results according to the instructions given by said user.

9. A method for managing test cases as claimed in claim (7), wherein said step of labeling said features, said step of labeling said sub features and said step of labeling said test cases are carried out manually.

10. A method for managing test cases as claimed in claim (7), wherein said step of labeling said features, said step of labeling said sub features and said step of labeling said test cases are carried out by automated processes.

11. A method for managing test cases, said method comprising the following steps:
creating products whose features are to be tested by testers;
identifying features and sub features for said created products;
labeling said identified features and sub features with unique feature identifiers;
creating test cases corresponding to each of said features and sub features;
labeling said created test cases with unique test case identifiers;
creating a table having a plurality of cells arranged in a plurality of rows and a plurality of columns so that each cell is identified by the unique co-ordinates of a row and a column;
mapping said features and sub features with said created test cases with the help of said created table by placing said feature identifier in a cell of a row and placing corresponding test case identifier in another cell of the same row; and
iterating said step of mapping for all said created test cases.
